(19) United States
(12) Patent Application Publication
(10) Pub. No.: US 2022/0414126 A1
(43) Pub. Date: Dec. 29, 2022

(54) VIRTUAL ASSISTANT FEEDBACK ADJUSTMENT

(71) Applicant: International Business Machines Corporation, Armonk, NY (US)

(72) Inventors: Ruchi Mahindru, Elmsford, NY (US); Martin Franz, Yorktown Heights, NY (US); Daniela Rosu, Mount Kisco, NY (US); Sinem Guven Kaya, New York, NY (US); Xin Zhou, Beijing (CN)

(21) Appl. No.: 17/361,742

(22) Filed: Jun. 29, 2021

(51) Int. Cl. G06F 16/335; G06F 16/332; G06F 16/33

(52) U.S. Cl. CPC G06F 16/337; G06F 16/3326; G06F 16/3334; G06F 16/3329

(57) ABSTRACT

A computer implemented method for analyzing feedback with respect to a virtual assistant includes identifying a technical support problem and a corresponding resolution, wherein the technical support problem corresponds to a query, and wherein the corresponding resolution corresponds to the virtual assistant's response, collecting user feedback provided by one or more users corresponding to the technical support problem and the corresponding resolution, creating a set of user profiles corresponding to the one or more users, generating weighted user feedback according to the set of user profiles, identifying contradictory feedback patterns corresponding to the one or more users, adjusting the set of user profiles according to the identified contradictory feedback patterns, and recommending improvements to the identified corresponding resolution.

### BACKGROUND

The present invention relates generally to the field of virtual assistance, and more specifically, to adjusting virtual assistant functionality according to user feedback.

The IT field is seeing increased prevalence of virtual assistants (VAs) or virtual agents for support staff. In general, virtual assistants (also referred to as virtual agents, intelligent virtual assistants (IVAs), or intelligent personal assistants (IPAs)) are software agents that can perform tasks or services for an individual based on commands or questions. With respect to virtual assistants generally accessed by online chat, the term “chatbot” may also be used. Some virtual assistants are able to interpret human speech and respond via text or via synthesized voices. Users can ask virtual assistants questions, control home automation devices and media playback via voice, and manage other basic tasks such as email, to-do lists, and calendar events with verbal commands and prompts.

### SUMMARY

As disclosed herein, a computer implemented method for analyzing feedback with respect to a virtual assistant includes identifying a technical support problem and a corresponding resolution, wherein the technical support problem corresponds to a query, and wherein the corresponding resolution corresponds to the virtual assistant's response, collecting user feedback provided by one or more users corresponding to the technical support problem and the corresponding resolution, creating a set of user profiles corresponding to the one or more users, generating weighted user feedback according to the set of user profiles, identifying contradictory feedback patterns corresponding to the one or more users, adjusting the set of user profiles according to the identified contradictory feedback patterns, and recommending improvements to the identified corresponding resolution. A computer program product and computer system corresponding to the method are also disclosed.

### BRIEF DESCRIPTION OF THE DRAWINGS

FIG. 1 is a block diagram depicting a virtual assistant feedback system in accordance with at least one embodiment of the present invention;

FIG. 2 is a flowchart depicting a virtual assistant improvement method in accordance with at least one embodiment of the present invention; and

FIG. 3 is a block diagram of components of a computing system in accordance with an embodiment of the present invention.

### DETAILED DESCRIPTION

When a virtual assistant is deployed, there is often no usage log data available to enable learning based on runtime data. Artificial intelligence (AI) model training requires a large amount of quality data, and it therefore may take a while for an effective feedback learning method to be trained and implemented. Additionally, IT support agents have different skills and expertise, and everyone's feedback may not be equivalent. Typically, systems are deployed and data is collected, and it may become apparent much later that usage data is not good quality (may be biased, skewed, etc.). Embodiments of the present invention enable feedback analysis on an ongoing basis, along with real time recommendations regarding how to provide better feedback, as well as improvement recommendations with respect to training.

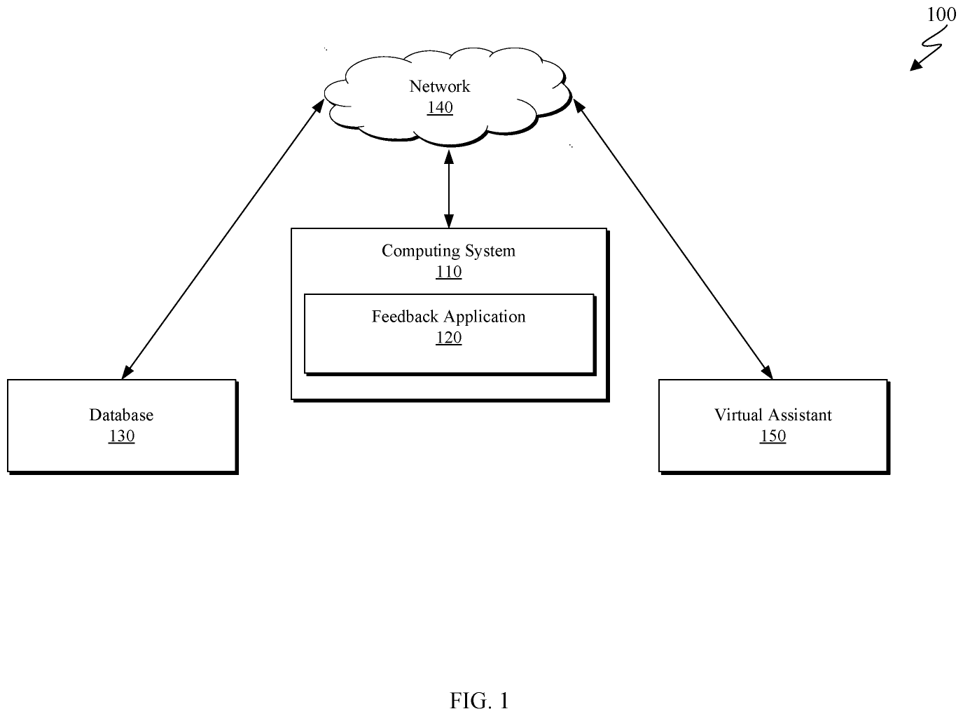

FIG. 1 is a block diagram depicting a virtual assistant feedback system 100 in accordance with at least one embodiment of the present invention. As depicted, virtual assistant feedback system 100 includes computing system 110, database 130, network 140, and virtual assistant 150. In general, virtual assistant feedback system 100 is configured to provide improved feedback to a virtual assistant application in a technical support environment.

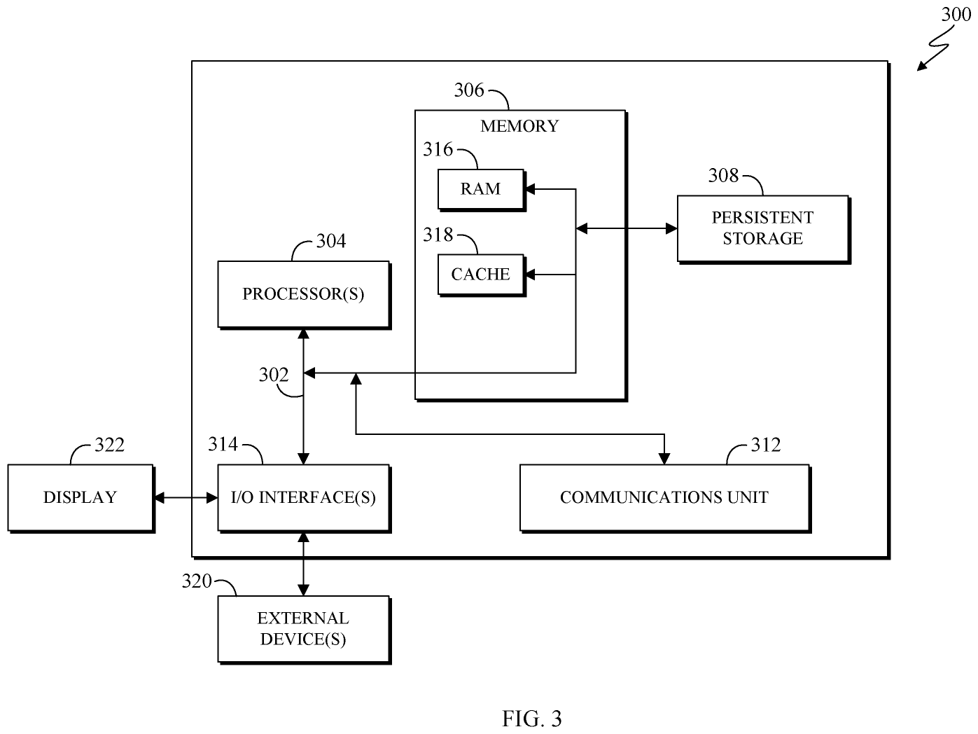

Computing system 110 can be a desktop computer, a laptop computer, a specialized computer server, or any other computer system known in the art. In some embodiments, computing system 110 represents computer systems utilizing clustered computers to act as a single pool of seamless resources. In general, computing system 110 is representative of any electronic device, or combination of electronic devices, capable of receiving and transmitting data, as described in greater detail with regard to FIG. 3. Computing system 110 may include internal and external hardware components, as depicted and described in further detail with respect to FIG. 3.

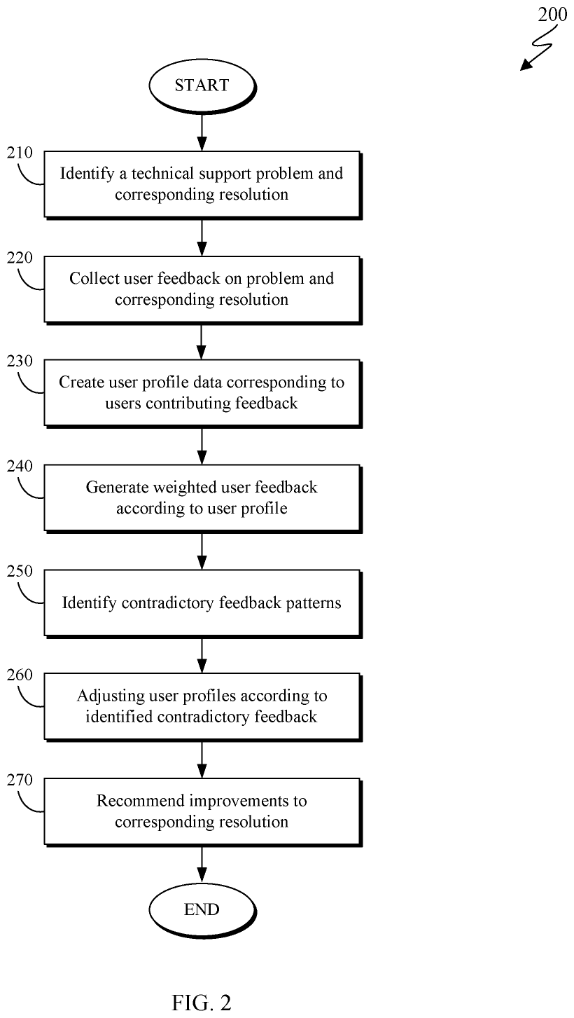

As depicted, computing system 110 includes feedback application 120. Feedback application 120 may be configured to receive user feedback with respect to a virtual assistant, such as connected virtual assistant 150. Feedback application 120 may additionally be configured to analyze the received user feedback via a virtual assistant feedback method such as the virtual assistant feedback method 200 described with respect to FIG. 2. In general, feedback application 120 is configured to receive and analyze data received via database 130 and virtual assistant 150.

Data store 130 may be configured to store received information and can be representative of one or more databases that give permissioned access to computing system 110 or publicly available databases. In general, data store 130 can be implemented using any non-volatile storage media known in the art. For example, data store 130 can be implemented with a tape library, optical library, one or more independent hard disk drives, or multiple hard disk drives in a redundant array of independent disk (RAID). Data store 130 may be configured to store usage log data, technical support problem data, corresponding resolution data, and user feedback data.

Network 140 can be, for example, a local area network (LAN), a wide area network (WAN) such as the Internet, or a combination of the two, and include wired, wireless, or fiber optics connections. In general, network 140 can be any combination of connections and protocols that will support communications between computing system 110, data store 130, and virtual assistant 150. Virtual assistant 150 may correspond to any virtual agent configured to provide IT support and generally respond to IT queries issued by users.

FIG. 2 is a flowchart depicting a virtual assistant feedback method 200 in accordance with at least one embodiment of the present invention. As depicted, virtual assistant improvement method 200 includes identifying (210) a technical support problem and a corresponding resolution, collecting (220) corresponding user feedback provided by one or more users, creating (230) a set of user profiles corresponding to the one or more users, generating (240) weighted user feedback according to the set of user profiles, identifying (250) contradictory feedback patterns, adjusting (260) the set of user profiles according to the identified contradictory feedback patterns and recommending (270) improvements to the identified corresponding resolution. Virtual assistant feedback method 200 offers improved virtual assistant functioning responsive to user feedback regarding the virtual assistant's performance.

Identifying (210) a technical support problem and a corresponding resolution may include receiving an indication from a user or an application of a selected technical support problem of interest. In at least some embodiments, identifying (210) a technical support problem includes querying a data store or other application for usage logs or other forms of usage data corresponding to a selected technical support problem. In at least some embodiments, identifying (210) a technical support problem and a corresponding resolution additionally includes prompting a user to manually identify or select a resolution corresponding to the technical support problem. In some exemplary embodiments, the technical support problem corresponds to a query issued to a technical support hub of sorts, and the corresponding resolution corresponds to a virtual assistant's (or virtual agent's) response to the posed query.

Collecting (220) corresponding user feedback provided by one or more users may include querying a data store or other application for user feedback data corresponding to the identified technical support problem and corresponding resolution. In at least some embodiments, the corresponding user feedback is previously provided feedback available via a data store or other application. In other embodiments, especially those where user feedback has not been provided with respect to the corresponding resolution, collecting (220) corresponding user feedback includes prompting one or more users to provide feedback with respect to the corresponding solution. In such embodiments, a graphical user interface may be provided to the user such that the user may provide feedback via the interface in a structured format. Collecting (220) corresponding user feedback provided by one or more users may generally include any combination of gathering historical feedback and actively prompting users for new/current feedback. In some embodiments, feedback may take explicit binary form (such as useful vs. not useful), or may be issued on a scale (usefulness from 1-10, with 1 being least useful and 10 being the most useful), etc. Feedback may also be expressed in terms of categories; for example, feedback may be classified as too naïve, too expert oriented, too detailed, or too vague.

Creating (230) a set of user profiles corresponding to the one or more users may include identifying which user feedback data corresponds to which user. In other words, creating (230) a set of user profiles may include tagging each instance of user feedback with a user (or users) who contributed to said feedback. Creating (230) a set of user profiles corresponding to the one or more users may further include creating a profile element which reflects the feedback the corresponding user has provided. In some embodiments, creating (230) a set of user profiles corresponding to the one or more users includes, for each user, creating a profile which includes the feedback as provided by said user. In other embodiments, creating (230) a set of user profiles corresponding to the one or more users includes, for each user, creating a profile which includes a representation of the feedback as provided by the user; in other words, rather than including the feedback itself, the profile may include a summary representation or analysis of the feedback the user has provided. For example, the user profile may include a shortened version of the feedback provided by the user, such as a rating or an indication of whether the feedback was generally positive or generally negative, etc. The user profile may additionally include additional identifying details for the user; for example, the user profile may be tagged with a platform via which the user typically provides their feedback, such that the feedback may be categorized and directed accordingly. The user profile may additionally include details such as user experience level and individual familiarity with the virtual assistant. In some embodiments, the user profile additionally includes details such as which domain or domains the user is familiar with.

Generating (240) weighted user feedback according to the set of user profiles may include identifying raw user feedback data with respect to a specified user. The identified raw user feedback data generally corresponds to an unaltered feedback indication as provided by the user (for example, the user's rating or description with no weighting applied). With respect to the identified raw user feedback data, generating (240) weighted user feedback according to the set of user profiles may further include identifying the user profile corresponding to the subject user, and identifying one or more profile items corresponding to the raw feedback data. For example, if the user profile indicates user experience level with respect to a platform of interest, and the identified raw user feedback data corresponds to said platform of interest, then the indicated user experience level is identified as pertinent or relevant. If the user profile indicates a user experience level on a platform unrelated to the identified raw user feedback data, then said indicated user experience level may be identified as irrelevant and may therefore not be considered when weighting the identified raw user feedback data. Generating (240) weighted user feedback according to the set of user profiles may include executing a similar analysis with respect to the identified raw user feedback data and the information available via the user profiles. In other words, generating (240) weighted user feedback includes determining which profile items are relevant with respect to the identified raw user feedback data. The user's feedback may be weighted more or less heavily (and thereby considered more or less important) based on the information in the user profile. For example, feedback from a user with limited experience with respect to a pertinent platform may be weighted half as heavily as feedback from a user with extensive experience with respect to said pertinent platform. With respect to a user, a user reliability score may be calculated with respect to feedback on certain platforms, certain queries, etc. Generating (240) weighted user feedback generally ensures that, when desirable, an expert user's feedback is given additional weight relative to a less experienced user's feedback.

Identifying (250) contradictory feedback patterns may include identifying instances of feedback which are in direct opposition to one another. In some embodiments, identifying (250) contradictory feedback patterns includes identifying instances in which a single user has issued contradictory feedback. In additional embodiments, identifying (250) contradictory feedback patterns includes identifying instances in which any number of users have issued contradictory feedback. Contradictory feedback in general refers to instances of feedback which are defined in opposing manners; in other words, a single user indicating that a VA's response to a query is not helpful and then at a separate time indicating that that VA's same response to said same query is indeed helpful would be considered contradictory. In some embodiments, contradictory feedback refers to feedback which is not aligned with the average feedback response. In other words, with respect to this definition, contradictory feedback would be a response from a user indicating that a VA's response to a query is very unhelpful, while the average feedback from all other user's indicates that the VA's response to the query is very helpful. The user's “very unhelpful” feedback may be flagged as contradictory, as it may be an indication that the user's measurement for how helpful a query response may not be accurate or fair. Identifying (250) contradictory feedback patterns may additionally include determining whether any users in particular display a pattern of contradictory feedback. In other words, identifying (250) contradictory feedback patterns may include identifying users for which many instances of contradictory feedback results exist.

Adjusting (260) the set of user profiles according to the identified contradictory feedback patterns may include identifying any users for whom many instances of contradictory feedback results existed relative to the total number of feedback results. With respect to a certain domain, platform, family of queries, or VA, a pattern of contradictory feedback from a single user may indicate that the user either fails to understand the responsibility of a VA with respect to the query response, or the user has unfair or unqualified expectations with respect to the query response from a VA. Accordingly, adjusting (260) the set of user profiles according to the identified contradictory feedback patterns may include adjusting a weighting coefficient with respect to the subject user profile such that feedback from the user who is not typically aligned with other “useful” feedback is not weighted equally with respect to other feedback provided. In some embodiments, adjusting (260) the set of user profiles according to the identified contradictory feedback patterns includes excluding feedback from such a user entirely; in other embodiments, adjusting (260) the set of user profiles includes minimizing the weighting of the feedback provided by such a user.

Recommending (270) improvements to the identified corresponding resolution may include aggregating the weighted user feedback to determine aggregated feedback. In at least some embodiments, recommending (270) improvements to the identified corresponding resolution is triggered responsive to aggregated feedback indicating a lack of general satisfaction with respect to the identified corresponding resolution. Accordingly, recommending (270) improvements to the identified corresponding resolution may occur differently based on whether the feedback analysis occurs in an offline environment or an active online environment. In an offline environment, recommending (270) improvements to the identified corresponding resolution may include generating a report for the owner of the VA indicating any feedback and comments provided. In embodiments where users are enabled to provide comments or other written feedback, recommending (270) improvements may include extracting actions indicated by the user feedback and providing an indication of the extracted actions to the user. In an active online environment, recommending (270) improvements to the identified corresponding resolution may include actively implementing recommended actions as indicated by users, and subsequently querying the user for revised feedback responsive to the implementation of said recommended actions. Recommending (270) improvements to the identified corresponding resolution may occur dependent on the classification of the feedback.

At various points in virtual assistant feedback method 200, data reliability may be implemented as a weighted factor as well; notably, less reliable feedback data may ideally be less heavily weighted than highly reliable feedback data. Calculating data reliability may occur by collecting usage log data including attributes such as, but not limited to, user ID, user experience level, user geography, user duration with virtual assistant, user query, context (such as product, brand, subseries, machine type, component, etc.), answer document ID, problem determination path, short feedback, form feedback, in-steep feedback, session ID, etc. Calculating data reliability may continue by applying rule based or machine learning based classifiers for situations where the feedback distribution is reflected in the same way data from the users is applied in training the AI model. For example, with respect to contradictory responses, if a user contradicts their own feedback above a configurable threshold, then the data or user may be considered unreliable. According to reliability calculations, the patterns revealed may be provided in a variety of forms, such as query ambiguity, user skill, content ambiguity, or a feedback profile.

Query ambiguity refers to the scenario in which there are multiple known problems or resolutions for similar queries and contexts and can ultimately lead to contradictory feedback. Query ambiguity is most identifiable when multiple users provide feedback on multiple problems or resolutions for the same queries and contexts. Recommended actions with respect to query ambiguity may include enabling automated ambiguous query detection by analyzing ambiguous queries to identify elements which contribute to the ambiguity, automating query refinement, eliminating usage records from data collection for model training which correspond to ambiguous queries and recommending manual query refinement.

User skill refers to scenarios in which a same user issues contradictory feedback for similar queries and contexts. In other words, user skill issues are prevalent where user X provides opposing feedback for two similar queries and contexts. Similarly, user skill issues may refer to instances in which a user frequently provides contradictory feedback compared to the feedback issued by other users. In at least some embodiments, lack of user skill may manifest as contradictory feedback for similar queries and contexts. Recommended actions with respect to user skill issues of this nature include delivering additional training or education to the subject user, adjusting the weight of said user's feedback from data collection for model training, and showing past feedback to the user to allow readjustment when appropriate.

Content ambiguity refers to scenarios in which a same query and context is answered using different answer documents. In other words, content ambiguity scenarios are identifiable in instances where a user selects different answer documents for the same query or context. Recommended actions with respect to content ambiguity concerns include improving available answer documents, or enhancing the existing documents ensuring that more detailed answer documents are made available.

Feedback profile refers to scenarios in which concerns surround what portion of users are providing feedback; in other words, who are the most critical users providing highest amounts of negative feedback, who is finding the subject VA useful, etc. Recommended actions to alleviate feedback profile concerns include implementing or providing additional training, leveraging peer training, improving content, as well as automating adjustments to agent experience levels, eliminating usage records from data collection for model training, or adjusting policies for determining a user's lifespan with the subject VA.

As described above, virtual assistant feedback method 200 is described with respect to user profiles, user feedback, user experience levels and the like. However, many aspects of virtual assistant feedback method 200 may additionally be implemented in a domain adaptation environment to identify and analyze patterns with respect to various domains, rather than various users, such that a user feedback process may be facilitated in a new domain such that patterns for a new domain are based on combining patterns present in the current domain in a manner that reflects the relations of the current domain to the old domain. Such a combination may be achieved by emphasizing patterns learned from deployed domains that are closer to the new target domain, and de-emphasizing patterns learned from the deployed domains that are not particularly similar to the new target domain.

FIG. 3 depicts a block diagram of components of computer 300 in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

As depicted, the computer 300 includes communications fabric 302, which provides communications between computer processor(s) 304, memory 306, persistent storage 308, communications unit 312, and input/output (I/O) interface(s) 314. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer-readable storage media. In this embodiment, memory 306 includes random access memory (RAM) 316 and cache memory 318. In general, memory 306 can include any suitable volatile or non-volatile computer-readable storage media.

One or more programs may be stored in persistent storage 308 for access and/or execution by one or more of the respective computer processors 304 via one or more memories of memory 306. In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 312, in these examples, provides for communications with other data processing systems or devices. In these examples, communications unit 312 includes one or more network interface cards. Communications unit 312 may provide communications through the use of either or both physical and wireless communications links.

I/O interface(s) 314 allows for input and output of data with other devices that may be connected to computer 300. For example, I/O interface 314 may provide a connection to external devices 320 such as a keyboard, keypad, a touch screen, and/or some other suitable input device. External devices 320 can also include portable computer-readable storage media such as, for example, thumb drives, portable optical or magnetic disks, and memory cards. Software and data used to practice embodiments of the present invention can be stored on such portable computer-readable storage media and can be loaded onto persistent storage 308 via I/O interface(s) 314. I/O interface(s) 314 also connect to a display 322.

Display 322 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method for analyzing feedback with respect to a virtual assistant, the computer implemented method comprising:
creating a user profile corresponding to a user, wherein the user profile includes a weight to be applied to user feedback corresponding to a virtual assistant's response to a user query;
identifying a contradictory feedback pattern corresponding to the user based, at least in part, on identifying instances in which the user provides feedback different from average feedback for the query;
adjusting the user profile according to the identified contradictory feedback pattern such that the user profile corresponding to the identified contradictory feedback pattern is assigned a lesser weight than other user profiles;
weighting the user feedback based, at least in part, on the user feedback to the virtual assistant's response to the user query and the adjusted user profile; and
recommending at least one improvement to the virtual assistant's response to the query based, at least in part, on the user feedback to the virtual assistant's response and the adjusted user profile.

2. The computer implemented method of claim 1, further comprising identifying one or more deficiencies indicated by the weighted user feedback.

3. The computer implemented method of claim 2, further comprising:
identifying a query ambiguity indicated by the weighted user feedback; and
enabling automated ambiguous query identification by analyzing the query ambiguity to identify elements contributing to said query ambiguity.

4. The computer implemented method of claim 2, further comprising:
identifying content ambiguity indicated by the weighted user feedback; and
recommending enhancing existing answer documents corresponding to the identified content ambiguity.

5. The computer implemented method of claim 2, further comprising:
identifying feedback profile concerns indicated by the weighted user feedback; and
recommending additional training or education with respect to users providing feedback.

6. The computer implemented method of claim 2, further comprising:
identifying user skill concerns indicated by the weighted user feedback; and
recommending adjusting user profiles corresponding to the users for which user skill concerns are identified.

7. The computer implemented method of claim 1, wherein contradictory feedback patterns are indicated by feedback from the user which is an outlier with respect to feedback from one or more other users.

8. A computer program product for analyzing feedback with respect to a virtual assistant, the computer program product comprising:
one or more computer readable storage media and program instructions stored on the one or more computer readable storage media, the program instructions comprising instructions to:
create a user profile corresponding to a user, wherein the user profile includes a weight to be applied to user feedback corresponding to a virtual assistant's response to a user query;
identify a contradictory feedback pattern corresponding to the user based, at least in part, on identifying instances in which the user provided feedback different from average feedback for the query;
adjust the user profile according to the identified contradictory feedback pattern such that the user profile corresponding to the identified contradictory feedback pattern is assigned a lesser weight than other user profiles;
weight the user feedback based, at least in part, on the user feedback to the virtual assistant's response to the user query and the adjusted user profile; and
recommend at least one improvement to the virtual assistant's response to the query based, at least in part, on the user feedback to the virtual assistant's response and the adjusted user profile.

9. The computer program product of claim 8, further comprising instructions to identify one or more deficiencies indicated by the weighted user feedback.

10. The computer program product of claim 9, further comprising instructions to:
identify a query ambiguity indicated by the weighted user feedback; and
enable automated ambiguous query identification by analyzing the query ambiguity to identify elements contributing to said query ambiguity.

11. The computer program product of claim 9, further comprising instructions to:
identify content ambiguity indicated by the weighted user feedback; and
recommend enhancing existing answer documents corresponding to the identified content ambiguity.

12. The computer program product of claim 9, further comprising instructions to:
identify feedback profile concerns indicated by the weighted user feedback; and
recommend additional training or education with respect to users providing feedback.

13. The computer program product of claim 9, further comprising instructions to:
identify user skill concerns indicated by the weighted user feedback; and
recommend adjusting user profiles corresponding to the users for which user skill concerns are identified.

14. The computer program product of claim 8, wherein contradictory feedback patterns are indicated by feedback from the user which is an outlier with respect to feedback from one or more other users.

15. A computer system for analyzing feedback with respect to a virtual assistant, the computer system comprising:
one or more computer processors;
one or more computer-readable storage media;
program instructions stored on the computer-readable storage media for execution by at least one of the one or more processors, the program instructions comprising instructions to:
create a user profile corresponding to a user, wherein the user profile includes a weight to be applied to user feedback corresponding to a virtual assistant's response to a user query;
identify a contradictory feedback pattern corresponding to the user based, at least in part, on identifying instances in which the user provided feedback different from average feedback for the query;
adjust the user profile according to the identified contradictory feedback pattern such that the user profile corresponding to the identified contradictory feedback pattern is assigned a lesser weight than other user profiles;
weight the user feedback based, at least in part, on the user feedback to the virtual assistant's response to the user query and the adjusted user profile; and
recommend at least one improvement to the virtual assistant's response to the query based, at least in part, on the user feedback to the virtual assistant's response and the adjusted user profile.

16. The computer system of claim 15, further comprising instructions to identify one or more deficiencies indicated by the weighted user feedback.

17. The computer system of claim 16, further comprising instructions to:
identify a query ambiguity indicated by the weighted user feedback; and
enable automated ambiguous query identification by analyzing the query ambiguity to identify elements contributing to said query ambiguity.

18. The computer system of claim 16, further comprising instructions to:
identify content ambiguity indicated by the weighted user feedback; and
recommend enhancing existing answer documents corresponding to the identified content ambiguity.

19. The computer system of claim 16, further comprising instructions to:
identify feedback profile concerns indicated by the weighted user feedback; and
recommend additional training or education with respect to users providing feedback.

20. The computer system of claim 16, further comprising instructions to:
identify user skill concerns indicated by the weighted user feedback; and
recommend adjusting user profiles corresponding to the users for which user skill concerns are identified.
